(19) United States
(12) Patent Application Publication
(10) Pub. No.: US 2006/0180526 A1
(43) Pub. Date: Aug. 17, 2006

(54) Blood treating set and cell treating set

(75) Inventors: Hiroyuki Sugawara, Tokyo (JP); Noboru Taguchi, Kanagawa (JP); Masahide Murakoshi, Kanagawa (JP)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: Terumo Kabushiki Kaisha, Tokyo (JP)

(21) Appl. No.: 10/549,623

(22) PCT Filed: Mar. 19, 2004
(86) PCT No.: PCT/JP04/03746

§ 371 Date: Sep. 19, 2005

(30) Foreign Application Priority Data
Mar. 20, 2003 (JP) 2003-79204

(51) Int. Cl. B01D 35/14

(52) U.S. Cl. 210/91; 210/512.1; 604/408; 604/410; 604/403

(57) ABSTRACT

A blood treating set, including a blood collecting device and a blood treating device, the blood collecting device further including a first bag for storing collected blood, a tube for guiding blood into the first bag, and a tube for discharging blood from the first bag. The blood treating device further includes a connected bag body having three bags, that are, a second bag for storing haematosis, a third bag, and a fourth bag. These bags are connected to each other through the tubes and a branch connector. Also, the tube connected to the second bag includes a filter installed midway in the tube. On the tube connected to the first bag and the tube connected to the filter, indications (markers) are placed at positions to show where these portions must be connected.

### TECHNICAL FIELD

The present invention relates to a blood treating set for treating collected blood, and a cell treating set for treating a liquid containing bio-derived cells.

### BACKGROUND ART

There has been known a blood bag system for separating collected blood, obtained by collection of whole blood from a donor, into three kinds of transfusion blood cell products, i.e., concentrated red blood cell (CRC), platelet concentrated (PC) and platelet-poor plasma (PPP) by centrifugation.

In such transfusion blood cell products, removal of leukocytes from the separated and preserved transfusion blood has been conducted immediately before transfusion to a patient, for preventing various post-transfusion side effects from occurring, which might otherwise be induced by mixing of leukocytes in the transfusion blood.

It is known, however, that in the case of blood obtained by blood donation, removal of leukocytes before separation and preservation promises better quality of the transfusion blood cell products. In view of this, to enable removal of leukocytes before separation and preservation of the blood, there has been developed a leukocyte removing filter system (in-line filter), in which a blood collecting vessel and a circuit including a filter are integrally connected to each other.

The in-line filter has all elements of the circuit, including the filter and a bag, connected in a closed system, and can treat blood in an aseptic manner, however, the system also has demerits of poor operability and a bulky configuration (i.e., the system as a whole is large in size).

In the in-line filter, further, collected blood, which is judged as inappropriate for preparation due to quantitative or qualitative reasons, is discarded. In this case, the system inclusive of an unused filter must be discarded collectively as a whole, which is economically inefficient. In order to solve this problem, there has been developed a system in which a blood collecting bag is separated from a filter and a circuit on the downstream side of the filter, and the components are connected at the time of the leukocyte removing step (see Japanese Patent No. 2952433).

This system includes a blood collecting bag, a first tube connected to the blood collecting bag, a leukocyte-free blood storage bag for storing the blood from which leukocytes have been removed (leukocyte-free blood), a second tube connected to the leukocyte-free blood storage bag, and a leukocyte removing filter disposed midway in the second tube. During the leukocyte removing treatment, the first tube and the second tube are connected at arbitrary portions thereof, the blood collecting bag is disposed at a higher position, whereas the leukocyte-free blood storage bag is disposed at a lower position, and a head (difference in height) between such positions is utilized to transfer the blood from the blood collecting bag to the leukocyte removing filter and to the leukocyte-free blood storage bag, sequentially.

Here, the filtration performance of the leukocyte removing filter tends to depend on the channel length. For example, if the channel length is too large, the head associated with filtration is lengthened, so that the flow-down velocity of the blood is high and the leukocyte removal rate is low. On the contrary, when the channel length is too small, the head associated with filtration is shortened, so that the flow-down velocity of the blood is low and the filtration time increases.

Therefore, it is known that if the circuit (channel) is not set to a prescribed length, proper filter performance will not be sufficiently exhibited, or a dispersion in filter performance will be generated, so that the leukocyte removal rate (quality of the blood products) will vary (i.e., be non-uniform) or workability will be lowered. However, in the system disclosed in Japanese Patent No. 2952433, the connected portion between the first tube and the second tube is arbitrary and cannot be specifically recognized by the worker, so that the length of the tube inclusive of the connected portion (channel length) cannot be constant, resulting in the above-mentioned demerits.

### DISCLOSURE OF THE INVENTION

An object of the present invention is to provide a blood treating set, together with a cell treating set for treating liquids containing bio-derived cells, in which, when tubes are connected to each other to form a channel, the length of the channel can easily and securely be made constant.

In order to attain the above object, according to the present invention, there is provided a blood treating set including: a blood collecting device including a first bag for storing collected blood, and a first tube for discharging the blood from the first bag; and a blood treating device including a second bag for storing blood or a blood component, and a second tube for leading the blood or blood component into the second bag. The first tube and the second tube are aseptically connected to each other. The blood or blood component is transferred by use of the first tube and the second tube, which are connected to each other. The first tube and/or the second tube is provided with an indication for indicating the connection position for the tubes.

This makes it possible, at the time of forming a channel by connecting the tubes to each other, to easily specify the connection position, and to easily make constant the length of the channel through a simple operation. Therefore, for example in the case where a filter is provided in the circuit, the filtration performance of the filter can be exhibited uniformly and sufficiently, and a high filtration efficiency can be stably obtained. In addition, in the case of conducting an operation for separating and recovering blood components by use of the blood treating set according to the present invention, not only the tube connecting operation, but also the overall operations of the blood treating set can be carried out easily, speedily and accurately.

In the blood treating set of the present invention, the indication preferably indicates the connection position for the first tube and the second tube as a predetermined region.

The blood treating set of the present invention is preferably configured so that, when the first tube and the second tube are connected to each other according to the indication, the length of the tubes after connection is substantially constant.

In addition, in order to attain the above object, according to the present invention, there is provided a blood treating set including: a blood collecting device including a first bag for storing collected blood, and a first tube for discharging the blood from the first bag; and a blood treating device including a second bag for storing blood or a blood component, and a second tube for leading the blood or blood component into the second bag. The first tube and the second tube are aseptically connected to each other. The blood or blood component is transferred by use of the first tube and the second tube, which are connected to each other. The first tube and/or the second tube is provided with a reduced diameter portion formed by reducing the tube diameter in a predetermined region inclusive of the connection position of the tubes, as compared with that in the other regions.

This makes it possible, at the time of forming a channel by connecting the tubes to each other, to easily determine the connection position, and to securely make constant the length of the channel through a simple operation. Therefore, for example in the case where a filter is provided in the circuit, the filtration performance of the filter can be exhibited uniformly and sufficiently, and a high filtration efficiency can be stably obtained. In addition, in the case of conducting an operation for separating and recovering blood components by use of the blood treating set according to the present invention, not only the tube connecting operation, but also the overall operations of the blood treating set can be carried out easily, speedily and accurately.

In the blood treating set according to the present invention, the reduced diameter portion preferably has an outside diameter such that the reduced diameter portion can be mounted in a tube holding part of a tube connecting device.

The blood treating set of the present invention is preferably configured so that, when the first tube and the second tube are connected to each other with the reduced diameter portion mounted in the tube holding part of the tube connecting device, the length of the tubes after connection is substantially constant.

The blood treating set of the present invention preferably has a filter for removing a predetermined component, the filter being provided at an intermediate portion or an end portion of the first tube or the second tube. In this case, the filter is preferably a leukocyte removing filter.

In the blood treating set of the present invention, the blood treating device preferably includes a connected bag body having the second bag and at least one other bag connected to the second bag.

In the blood treating set of the present invention, the blood treating device is preferably operative to conduct a blood separating treatment for separating blood into a plurality of blood components by centrifugation and recovery of the blood components.

Further, in order to attain the above object, according to the present invention, there is provided a cell treating set including: a liquid storing device including a first bag for storing a liquid containing bio-derived cells, and a first tube for discharging the liquid from the first bag; a cell treating device including a second bag for storing the treated liquid, and a second tube for leading the treated liquid into the second bag; and a filter for separating a predetermined component of the liquid. The filter is provided midway in the first tube or the second tube. The first tube and the second tube are aseptically connected to each other. The liquid is transferred by use of the first tube and the second tube, which are connected to each other. The first tube and/or the second tube is provided with an indication for indicating a connection position for the tubes.

This makes it possible, at the time of forming a channel by connecting the tubes to each other, to easily determine the connection position, and to securely make constant the length of the channel through a simple operation. Therefore, for example in the case where a filter is provided in the circuit, the filtration performance of the filter can be exhibited uniformly and sufficiently, and a high filtration efficiency can be stably obtained. In addition, in the case of conducting an operation for separating and recovering cells by use of the cell treating set according to the present invention, not only the tube connecting operation, but also the overall operations of the cell treating set can be carried out easily, speedily and accurately.

In the cell treating set according to the present invention, the indication preferably indicates the connection position for the first tube and the second tube as a predetermined region.

The cell treating set of the present invention is preferably configured so that, when the first tube and the second tube are connected to each other according to the indication, the length of the tubes after connection is substantially constant.

### BRIEF DESCRIPTION OF THE DRAWINGS

FIG. 1 is a plan view schematically showing a first embodiment of the blood treating set according to the present invention;

FIG. 2 is a perspective view showing one example of the configuration and operation of a tube connecting device used for connection between tubes;

FIG. 3 is a perspective view showing one example of the configuration and operation of the tube connecting device used for connection between tubes;

FIG. 4 is a perspective view showing one example of the configuration and operation of the tube connecting device used for connection between tubes;

FIG. 5 is a perspective view showing one example of the configuration and operation of the tube connecting device used for connection between tubes;

FIG. 6 is a perspective view showing one example of the configuration and operation of the tube connecting device used for connection between tubes;

FIG. 7 is a perspective view showing one example of indications (markers) provided on tubes; and

FIG. 8 is a plan view schematically showing a second embodiment of the blood treating set according to the present invention.

### BEST MODE FOR CARRYING OUT THE INVENTION

Now, the blood treating set according to the present invention will be described in detail below, based on preferred embodiments shown in the accompanying drawings.

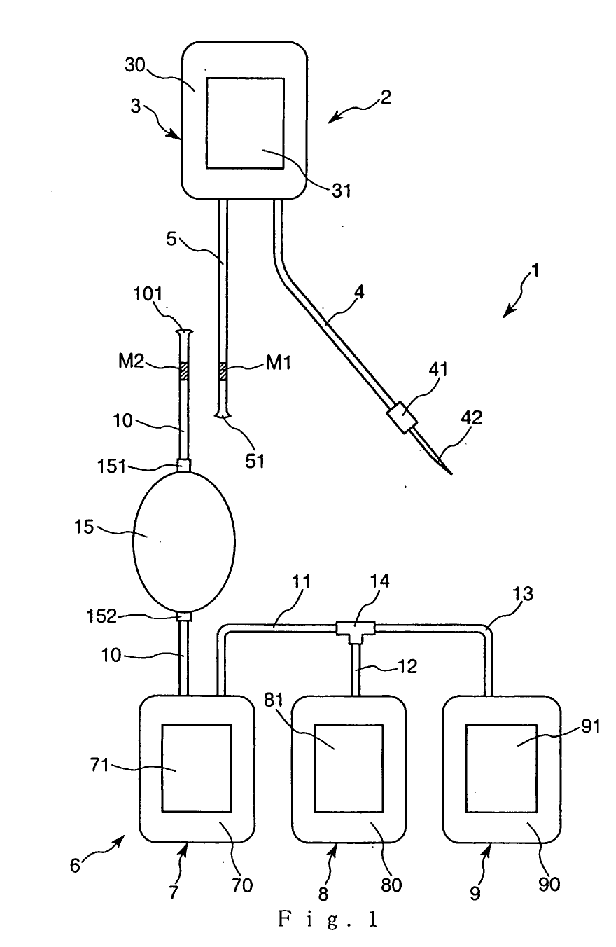

FIG. 1 is a plan view schematically showing a first embodiment of the blood treating set according to the present invention. The blood treating set 1 shown in the figure includes a blood collecting device 2 and a blood treating device 6. The blood collecting device 2 and the blood treating device 6 are separate from each other before use, and are connected to each other when used.

The blood collecting device 2 includes a first bag 3 for storing collected blood, a tube (blood collecting tube) 4 for leading the blood into the first bag 3, and a tube (first tube) 5 for discharging the blood from the first bag 3.

The first bag 3 has a bag body 30 formed in a bag-like shape by laying flexible sheet materials on each other and fusing (sealing) the peripheries of the sheet materials.

Examples of the material constituting the bag body 30 include polyvinyl chloride, soft polyvinyl chloride, materials containing soft polyvinyl chloride as a main constituent (for example, copolymers with small amounts of other polymeric materials, polymer blends, polymer alloys, etc.), and ethylene-vinyl acetate copolymers.

It is preferable that an anticoagulant is preliminarily placed in the first bag 3. The anticoagulant is ordinarily a liquid, and examples thereof include ACD-A liquid, CPD liquid, CPDA-1 liquid, and haparin sodium liquid. The amount of the anticoagulant in the bag body 30 is set at an appropriate amount according to the planned amount of blood to be collected.

As shown in FIG. 1, one side-end of the flexible tube 4 and one side end of the flexible tube 5 (first tube) are connected to a lower end portion in FIG. 1 of the first bag 3, so that the tubes communicate with the inside (blood storing portion) of the first bag 3.

The tube 4 is a tube for leading blood into the first bag 3, and the tube 5 is a tube for discharging the blood from the first bag 3 and feeding the blood to a filter 15 which will be described later.

A blood collecting needle 42 is mounted to the other end of the tube 4 through a hub 41. A cap (not shown) for covering the blood collecting needle 42 is mounted to the hub 41. The other end (the lower end in FIG. 1) of the tube 5 is sealed by fusing or the like, to form a sealed end portion 51.

Incidentally, while the two tubes consisting of the tube 4 for leading the blood into the bag body 30 and the tube 5 for discharging the blood from the inside of the bag body 30 are connected to the first bag 3 in the embodiment shown in the figure, this configuration is not limitative, and only the tube 4 may be connected to the first bag 3.

In this case, an indication (marker) M1, which will be described later, is provided midway on the tube 4. After the blood is led into the bag body 30, the other end side of the tube 4 (the portion on the hub 41 side relative to the indication (marker) M1) is sealed by fusing using a tube sealer or the like, then the sealed portion is cut, and the hub 41 and the blood collecting needle 42 are removed. With the indications (markers) M1 and M2 as aims, the tube (first tube) 4 is connected to a tube 10 in the manner described later, so that the blood in the bag body 30 can be discharged and transferred through the tubes 4 and 10.

The blood treating device 6 is used for separating blood into a plurality of blood components and recovering a predetermined one or more of the blood components into a bag. The blood treating device 6 is composed of a connected bag body having three bags, i.e., a second bag (erythrocyte bag) 7, a third bag (platelet bag) 8, and a fourth bag (plasma bag) 9 for storing the blood components.

The second bag 7, the third bag 8 and the fourth bag 9 have bag bodies 70, 80 and 90 each of which is obtained in a bag-like shape by laying flexible sheet materials on each other and fusing (sealing) the peripheries of the sheet materials.

Examples of the materials constituting the bag bodies 70, 80 and 90 include polyvinyl chloride, soft polyvinyl chloride, materials containing soft polyvinyl chloride as a main constituent (for example, copolymers with small amounts of other polymeric material, polymer blends, polymer alloys, etc.), and ethylene-vinyl acetate copolymers.

It is preferable that an erythrocyte preserving liquid is preliminarily placed inside the fourth bag 9 (within the bag body 70). The erythrocyte preserving liquid is ordinarily a liquid, and examples thereof include SAGM liquid, OPTISOL liquid, and MAP liquid. The amount of the erythrocyte preserving liquid in the bag body 90 is set at an appropriate amount according to the planned amount of blood to be collected.

One side end of the flexible tube 10 and one side end of the flexible tube 11 are connected to an upper end portion in FIG. 1 of the second bag 7, so that the tubes communicate with the inside (blood component storing portion) of the second bag 7. The tube (second tube) 10 is a tube for leading blood or a blood component into the second bag 7, and the tube 11 is a tube for transferring the blood component from the second bag 7 to the third bag 8.

One side end of the flexible tube 12 and one side end of the flexible tube 13 are connected respectively to upper end portions of the third bag 8 and the fourth bag 9 in FIG. 1, so that the tubes 12 and 13 communicate with the inside (blood component storing part) of the third bag 8 and the inside (blood component storing part) of the fourth bag 9, respectively. The other ends of the tubes 11, 12 and 13 are connected respectively to three ports of a branch connector 14.

With such a configuration, the second to fourth bags 7 to 9 are connected to each other through the tube 11, the tube 12, the tube 13 and the branch connector 14, and the inside portions of the bags communicate with each other.

Examples of the materials constituting the tubes 4, 5, 10, 11, 12 and 13 include polyvinyl chloride, soft polyvinyl chloride, materials containing soft polyvinyl chloride as a main constituent (for example, copolymers with small amounts of other polymeric materials, polymer blends, polymer alloys, etc.), and ethylene-vinyl acetate copolymers.

The other end (the upper end in FIG. 1) of the tube 10 that communicates with the inside of the second bag 7 is sealed by fusing or the like, to form a sealed end portion 101. In addition, a filter 15 is disposed midway in the tube 10.

The filter 15 includes a housing, and a filter medium is provided inside the housing. From the blood introduced into the filter 15 through an inlet 151, a desired component (unnecessary matter) is filtered off by the filter medium, and then the blood is sent out via an outlet 152.

Examples of the material constituting the housing of the filter 15 include polycarbonate, polyvinyl chloride, soft polyvinyl chloride, ethylene-vinyl acetate copolymers, acrylonitrile-butadiene-styrene copolymers (ABS resin), and acrylonitrile-styrene copolymers (AS resin).

On the other hand, examples of the material constituting the filter medium include porous bodies, nonwoven fabrics and the like of polyether type polyurethane, polyester type polyurethane, polyethylene terephthalate, and polybutylene terephthalte.

The type of filter 15 is not particularly limited, and may be appropriately selected according to its use and the like. Classified by the components to be filtered out, examples of the filter 15 may include a leukocyte removing filter, a microaggregate removing filter, a virus removing filter, and an endotoxin removing filter. The filter 15 may also be a filter for removing bacteria, prions, pathogenic substances, or the like.

Leukocyte removing filters include types for separating only leukocytes (this may separate one or more of lymphocytes, granulocytes, and monocytes), and types for filtering out leukocytes and platelets; further, the filters can be designed to simultaneously filter out microaggregates.

In addition, microaggregate removing filters include types for filtering out only microaggregates, and types for filtering out microaggregates and platelets.

Virus removing filters may include types for filtering out only viruses (for example, HAV, HBV, HCV, HIV, HTLV-I, CMV, Parvovirus B19, Filovirus, Hantavirus, etc.), and types for filtering out either one or both of endotoxins and microaggregates together with viruses. In addition, the filters can be designed to further filter out leukocytes and platelets selectively.

Endotoxin removing filters may include types for filtering out only endotoxins, and types for filtering out either one or both of viruses and microaggregates together with endotoxins. In addition, the filters can be designed to further filter out leukocytes and platelets selectively.

Incidentally, in the following description, the filter 15 will be described representatively as being a leukocyte removing filter, for filtering out (separating) leukocytes from blood.

Labels 31, 71, 81 and 91 are adhered respectively to the bag bodies 30, 70, 80 and 90. The labels 31, 71, 81 and 91 have pressure sensitive adhesive layers on the back side thereof, and are adhered respectively to surfaces of the bag bodies 30, 70, 80 and 90 through such pressure sensitive adhesive layers.

The labels 31, 71, 81 and 91 carry thereon information related to the contents of the bags to which they are adhered, for example by printing. Examples of the information indicated on the labels include the kind of blood component stored, the capacity of the bag, blood type, date of blood collection, and donor data (name, age, sex, etc.). As for the method of indication, the information may be directly indicated in characters, figures, symbols and the like, or the information may be indicated in a coded state (for example, a bar code or a two-dimensional code).

It is preferable if it is difficult for the labels 31, 71, 81 and 91 to be exfoliated from the surfaces of the bag bodies 30, 70, 80 and 90, so as to be tamperproof.

The blood treating set 1 described above is used with the blood collecting device 2 and the blood treating device 6 connected to each other. Specifically, the tube 5 of the blood collecting device 2 and the tube 10 of the blood treating device 6 are aseptically cut and connected through fusing, and blood is transferred from the first bag 3 to the second bag 7 side by use of the tubes thus connected.

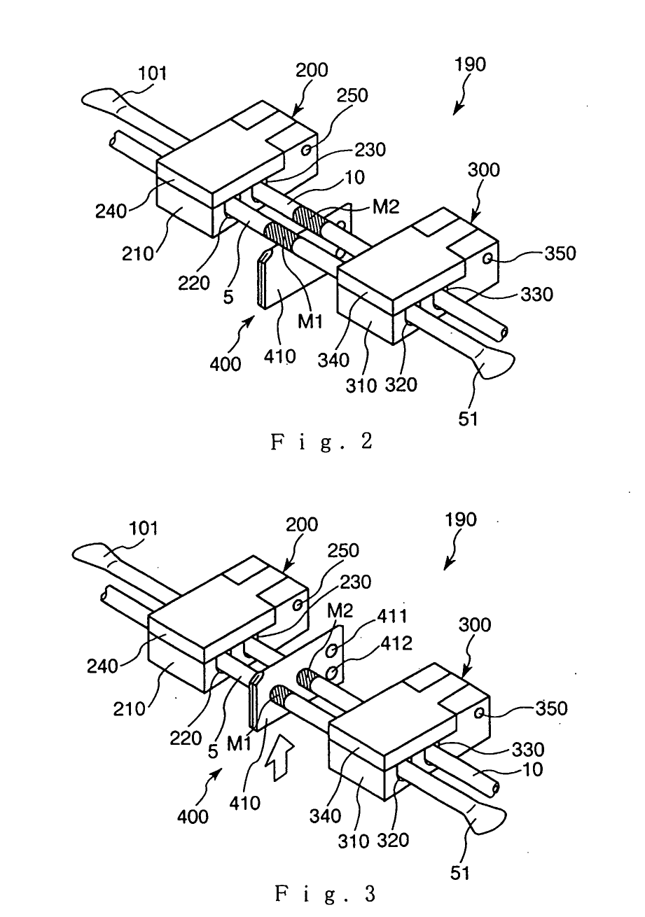

Next, a method of using the tube 5 and the tube 10 will be described in detail below. The tube 5 and the tube 10 are connected, for example, by a tube connecting device (aseptic tube connecting device) 190, as shown in FIGS. 2 to 6.

The tube connecting device 190 includes a first tube holding device (tube holding part) 200, a second tube holding device (tube holding part) 300, a cutting means 400 for cutting the tubes 5 and 10 by heating and melting, and tube holding and moving means (not shown) for moving the first tube holding device 200 and the second tube holding device 300 respectively in predetermined directions.

The first tube holding device 200 includes a holder 210 for holding the tubes 5 and 10, and a lid body 240 rotatably mounted to a rear end portion of the holder 210 by a hinge 250 and operative to be opened and closed. The holder 210 is provided with a pair of parallel grooves 220 and 230 in which the two tubes 5 and 10 are mounted, respectively. The grooves 220 and 230 are U-shaped in cross section.

The lid body 240 is configured so as to cover the grooves 220 and 230 when closed, and securely fix the tubes 5 and 10 mounted in the grooves 220 and 230, so that the tubes will not become disengaged. In addition, the first tube holding device 200 has a lock mechanism (not shown) for maintaining the closed condition of the lid body 240.

On the other hand, the second tube holding device 300 is disposed on a lateral side of the first tube holding device 200, with a predetermined spacing therebetween. Like the first tube holding device 200, the second tube holding device 300 includes a holder 310 provided with a pair of grooves 320 and 330, and a lid body 340 rotatably (openably and closably) mounted to the holder 310 by a hinge 350. In addition, the second tube holding device 300 also has the above-mentioned lock mechanism.

The first tube holding device 200 and the second tube holding device 300 are arranged so that, normally, the grooves 220 and 320 coincide with each other (are disposed along a straight line) and the grooves 230 and 330 coincide with each other (are disposed along a straight line).

The cutting means 400 includes a cutting plate (wafer) 410 for melting and cutting the tubes 5 and 10, and a cutting plate moving means (not shown) for inserting and retracting the cutting plate 410 into and from the gap between the first and second tube holding devices 200 and 300.

The cutting plate 410 is a self-heating type of thermal cutting plate, and has a configuration in which a metallic sheet such as a copper sheet is folded in two, a resistor for heating is provided in a desired pattern on the inside of the folded sheet through insulating layers, and terminals 411 and 412 at both ends of the resistor are exposed through openings formed in one end portion of the metallic sheet.

When an electric current is passed to the terminals 411 and 412 by a predetermined energizing means, the resistor on the inside of the cutting plate 410 generates heat, and the cutting plate 410 is heated to a temperature (e.g., about 260° to 320° C.) at which the tubes 5 and 10 can be melted and cut. Incidentally, it is preferable for the cutting plate 410 to be expendable (single-use) with respect to each tube connecting step. In this case, a configuration can be adopted in which the cutting plate 410, which is mounted in a cutting plate holding member, is replaced after each tube connection, by a predetermined cutting plate replacing means (not shown).

Next, operation of the tube connecting device 190 will be described below, with reference to FIGS. 2 to 6. FIGS. 2 to 6 are perspective views schematically showing the steps for performing a tube connection, implemented by the tube connecting device 190.

The tubes 5 and 10 are mounted respectively in the grooves 220, 320 and 230, 330 of the holders, the lid bodies 240, 340 are closed, and the lock mechanisms are locked (i.e., placed in the condition shown in FIG. 2). An end portion (sealed end portion 51) of the tube 5 and an end portion (sealed end portion 101) of the tube 10 are sealed (closed in a gas-tight manner) by fusing.

Mounting of the tubes 5 and 10 into the first tube holding device 200 and the second tube holding device 300 is preferably conducted such that the indication M1 (described later) provided on the tube 5 and the indication M2 (described later) provided on the tube 10 are located at or near a substantially middle position between the holders 210 and 310, i.e., at or near the cutting position of the cutting plate 410. This makes it possible to accurately regulate the length (channel length) of the tubes 5, 10 after connection.

Next, the tubes 5 and 10 are cut and connected in respective steps. A voltage of, for example, 15 to 24 V is impressed between terminals 411 and 412 of the cutting plate 410 by the energizing means, whereby the cutting plate 410 is heated up to a temperature (e.g., about 260° to 320° C.) higher than the melting temperature of the tubes 5, 10, and the cutting plate 410 is gradually raised in the direction of the arrow shown in FIG. 3, by operation of the cutting plate moving means. As a result, the tubes 5 and 10 are melted and cut between the first tube holding device 200 and the second tube holding device 300. In the configuration shown in the figures, the tubes 5 and 10 are cut within the regions of the indications (markers) M1 and M2, respectively.

Incidentally, at the time of melting and cutting the tubes 5, 10, the cut end portions of the tubes 5, 10 are at high temperatures where the resin is in a molten or softened state, and are not communicated with the exterior, so that the sterile state of the channel is maintained.

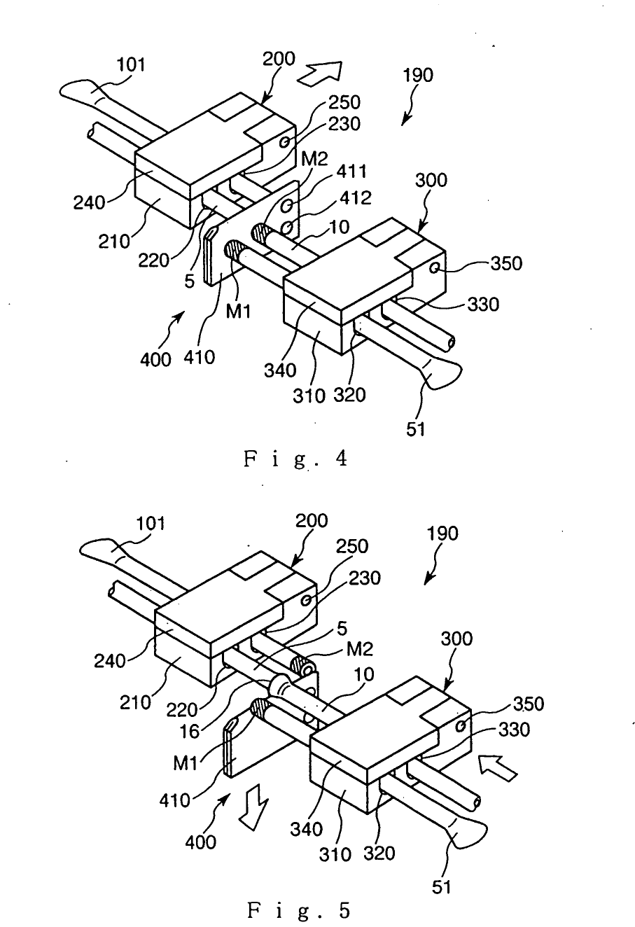

Immediately after melting and cutting of the tubes 5, 10, the first tube holding device 200 is moved in the direction of the arrow shown in FIG. 4, by operation of the tube holding device moving means. In this case, the moving distance of the first tube holding device 200 is such that the cut end of the tube 5 and the cut end of the tube 10 coincide with each other, i.e., a distance equivalent to the spacing between the grooves 220 and 230.

Subsequently, the cutting plate 410 is lowered (moved in the direction of the arrow shown in FIG. 5) to a retracted position, and is drawn out from the tubes 5, 10, by operation of the cutting plate moving means. Substantially simultaneously, one of the first tube holding device 200 and the second tube holding device 300 is moved toward the other, by operation of the tube holding device moving means. As a result, the cut ends of the tubes 5, 10 are pressed against each other, the joint portion 16 is firmly adhered, and gas-tightness and sterility are secured.

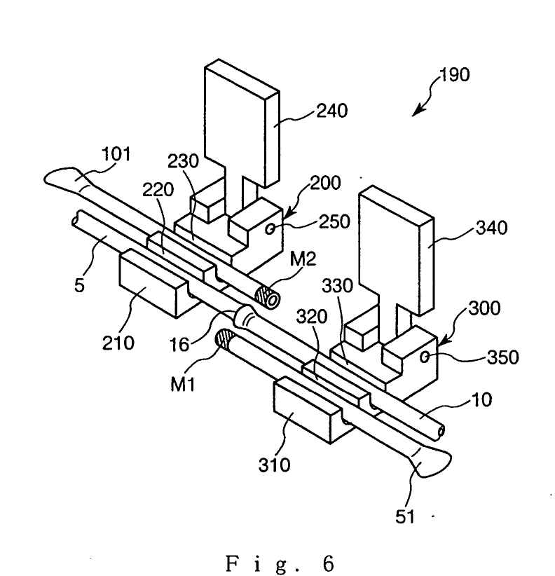

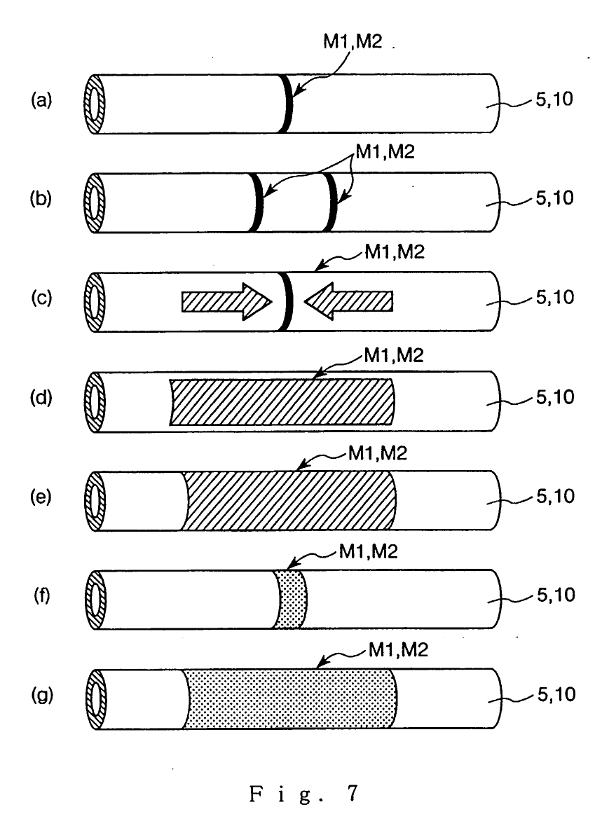

When the tube 5 and the tube 10 have been connected in this manner, locking of the first tube holding device 200 and the second tube holding device 300 by the lock mechanism is canceled, the lid bodies 240 and 340 are opened, and the connected tubes 5, 10 are taken out of the grooves 220, 320 (see FIG. 6). In addition, the two short tubes inclusive of the sealed end portions 51, 101 are also taken out and discarded.

In connecting the tubes 5 and 10 to each other, in the present invention, at least one, and preferably both, of the tubes 5 and 10 are provided with indications (markers) for indicating the connection position for the tubes. In the embodiment shown in the figures, the tubes 5 and 10 are provided with indications (markers) M1 and M2 at their connection positions, respectively. Then, the tubes 5 and 10 are aseptically connected to each other by use of the above-mentioned tube connecting device 190 and the like, according to the indications M1 and M2 (i.e., using the indications M1, M2 as aims).

By connecting the tubes 5 and 10 in this manner, the circuit length (channel length) between the first bag 3 and the second bag 7, particularly, the circuit length (channel length) from the end on the first bag 3 side of the tube 5 to the inlet 151 of the filter 15, can be made constant through a simple operation. As a result, in the case where the first bag 3 is placed (suspended) at a higher position and blood is transferred by a head (difference in height) between the first bag 3 and the second bag 7, the filtration performance of the filter 15 is sufficiently exhibited without dispersion, the leukocyte removal rate becomes uniform, and a high removal rate can be obtained. Therefore, the quality of the obtained blood products is enhanced.

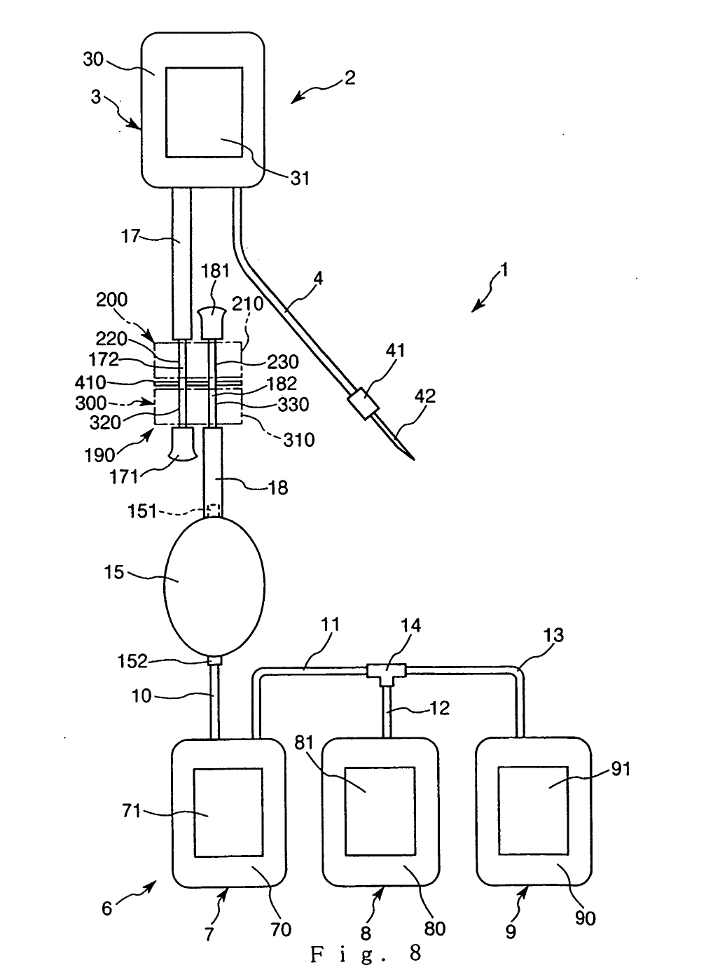

FIGS. 7(a) to 7(g) are perspective views, each of which shows one example of the indication (marker) M1, M2. Each of these examples shall be described below.

(a) A line form indication (marker) M1, M2 is formed at the connection position of the tube 5, 10 over the entire circumference of the tube 5, 10.

(b) Two line form indications (markers) M1, M2 are formed over the entire circumference of the tube 5, 10, with a predetermined spacing in the tube's longitudinal direction between the two lines. In this case, the portion between the two lines indicates the connection position, or region (tolerance) thereof, of the tube 5, 10.

(c) A line is formed at the connection position of the tube 5, 10 over the entire circumference of the tube 5, 10, and, further, arrows are formed on both sides of the line. These marks, as a whole, function as an indication (marker) M1, M2.

(d) (e) An indication (marker) M1, M2 is formed in a predetermined region along the longitudinal direction of the tube 5, 10. This indication (marker) indicates the connection position of the tube 5, 10 in the form of a predetermined region (tolerance). The indication M1, M2 shown in (d) is formed partially in the circumferential direction of the tube 5, 10, while the indication M1, M2 shown in (e) is formed over the entire circumference of the tube 5, 10.

(f) (g) An indication (marker) M1, M2 is formed by applying surface roughening (embossing or the like) to the surface of the tube 5, 10 at the connection position of the tube 5, 10. The indication M1, M2 shown in (f) is formed in a line or belt form at the connection position of the tube 5, 10, while the indication M1, M2 shown in (g) indicates the connection position of the tube 5, 10 in the form of a predetermined region (tolerance).

Incidentally, the indications M1, M2 shown in FIGS. 7(a) to 7(g) are merely examples, and are not limitative. Any configurations, such as appropriate combinations of the configurations of FIGS. 7(a) to 7(g), or various other configurations and the like may be adopted.

The method of forming the indications M1, M2 as described above is not particularly limited. Examples of the indication forming method include printing processes such as printing in inks, laser beam printing, etc., marking, transcription (transfer), the above-mentioned surface roughening (embossing or the like), sticking of a label or tape, mounting of a ring, band, belt or the like, and a change in the tube material, or color of the tube, itself.

Now, one example of a method of using the blood treating set 1 according to this embodiment will be described below. Incidentally, the filter 15 will be described representatively as being a leukocyte removing filter.

[1] First, the blood collecting needle 42 of the blood collecting device 2 is caused to puncture a blood vessel of a donor to thereby collect blood, and a predetermined amount of collected blood is secured in the first bag 3. In this instance, since the blood collecting device 2 is separate from the blood treating device 6, the blood collecting work can be carried out easily.

After blood collection, if necessary, an intermediate portion of the tube 4 is sealed by fusing, using a tube sealer or the like, then the sealed portion is cut, and the tube 4 on the blood collecting needle 42 side is separated and removed.

[2] Next, the tube 5 and the tube 10 are aseptically connected to each other by the above-mentioned tube connecting device 190. In this case, while visually checking the indications (markers) M1 and M2, the connection positions of the tubes 5 and 10 are specified according to the indications, and the tubes are connected. As a result, the tube connecting operation can be performed easily and securely, and the circuit length (channel length) between the first bag 3 and the second bag 7, which exists after the tube connection, particularly, the circuit length (channel length) from the end portion on the first bag 3 side of the tube 5 to the inlet 151 of the filter 15, can be made constant.

Incidentally, the length of the tubes 5 and 10, after being connected using the indications M1, M2 as aims in the above-mentioned manner, is appropriately set according to the characteristics of the filter 15 used, as well as other similar factors.

[3] Next, the blood in the first bag 3 is filtered by the filter 15. Specifically, leukocytes are filtered out (separated) from the blood. In this case, for example, the first bag 3 storing the blood therein is disposed at a higher position, by suspending it from a stand or the like, and the blood is transferred utilizing gravity.

By this operation, the blood in the first bag 2 flows through the tubes 5 and 10 and through the inlet 151 into the filter 15, where leukocytes are filtered out (separated) by the filter medium. The blood from which leukocytes have been removed (leukocyte-free blood) flows out via the outlet 152, is led through the tube 10 into the second bag 7, and is thereby recovered.

As has been described above, the circuit length (channel length) from the end portion on the first bag 3 side of the tube 5 to the inlet 151 of the filter 15 is constant, so that the rate of filtration by the filter 15 is constant, and the filtering performance is exhibited uniformly and sufficiently. As a result, the leukocyte removal rate in the filter 15 becomes uniform, a high removal rate can be obtained, and the quality of the blood products (blood components such as erythrocytes, platelets, plasma, etc.) ultimately obtained is enhanced.

[4] Next, an intermediate portion of the tube 10 between the filter 15 and the second bag 7 is sealed by fusing, using a tube sealer or the like, the sealed portion is cut, and the second bag 7 is separated from the blood collecting device 2 and the filter 15.

[5] Subsequently, the second bag 7, the third bag 8 and the fourth bag 9 are collectively placed in a centrifugal cup of a centrifugal separator, and the centrifugal separator is operated to perform centrifugation. As a result, the leukocyte-free blood stored in the second bag 7 is separated into, for example, a layer of erythrocytes and a layer of platelet-rich plasma in this order from the lower side. Incidentally, such a blood component separation pattern is determined according to centrifugation conditions (centrifugal rotating speed, centrifugation time, etc.)

[6] Next, from the blood components separated into two layers inside the second bag 7, the platelet-rich plasma, as a supernatant, is transferred into the third bag 8. The method of transferring is performed as follows.

In a condition where the second bag 7 is set on a blood component separating and transferring device (bag pressurizing device) and the tube 13 is sealed by a clamp, the second bag 7 is gradually pressurized. As a result, the platelet-rich plasma, as a supernatant, is discharged from the second bag 7, is transferred through the tube 11, the branch connector 14, and the tube 12 into the third bag 8, and is recovered.

[7] After transfer of the platelet-rich plasma has been completed, sealing of the tube 13 by the clamp is canceled, and in a condition where the tube 12 is sealed by the clamp, a erythrocyte preserving liquid in the fourth bag 9 is transferred through the tube 13, the branch connector 14, and the tube 11, and is added to the erythrocytes in the second bag 7.

[8] Next, an intermediate portion of the tube 11 is sealed by fusing, using a tube sealer or the like, the sealed portion is cut, and the second bag 7 is separated from the third bag 8 and the fourth bag 9. Then, the erythrocytes and the erythrocyte preserving liquid are mixed sufficiently in the second bag 7.

As a result, a second bag 7 filled with erythrocytes (concentrated red blood cell (CRC)) is obtained.

[9] Subsequently, the third bag 8 and the fourth bag 9 are collectively placed in a centrifugal cup of a centrifugal separator, and the centrifugal separator is operated to perform centrifugation.

As a result, the platelet-rich plasma stored in the third bag 8 is separated into platelet pellets (sediment) and plasma (platelet-poor plasma).

Incidentally, such a blood component separation pattern is determined according to the centrifugation conditions.

[10] Next, the third bag 8 is set on the blood component separating and transferring device (bag pressurizing device), and the third bag 8 is gradually pressurized.

As a result, plasma is discharged from the third bag 8, and is transferred through the tube 12, the branch connector 14, and the tube 13, into the fourth bag 9. In this instance, for suspending the platelet pellets to prepare platelet concentrated, plasma may be left in the third bag 8 in an amount suited to this purpose.

[11] Subsequently, intermediate portions of the tube 12 and the tube 13 are sealed by fusing, using a tube sealer or the like, the sealed portions are cut, and the third bag 8 and the fourth bag 9 are separated from each other. Then, the platelet pellets are suspended in plasma in the third bag 8.

As a result, a third bag 8 filled with platelets (platelet concentrated (PC)) and a fourth bag 9 filled with plasma (platelet-poor plasma (PPP)) are obtained.

By the foregoing, various blood products, i.e., the second bag 7 filled with erythrocytes (concentrated red blood cell (CRC)), the third bag 8 filled with platelets (platelet concentrated (PC)), and the fourth bag 9 filled with plasma (platelet-poor plasma (PPP)) are obtained.

Incidentally, the blood separating and recovering operation, according to the above-mentioned steps, is presented merely as one example. In the present invention, the kinds of blood components to be separated and recovered from blood, the bags used, the operating procedure and the like, are not particularly limited.

Now, a second embodiment of the blood treating set according to the present invention will be described below.

FIG. 8 is a plan view schematically showing the second embodiment of the blood treating set of the present invention. Next, the blood treating set 1 according to the second embodiment will be described, referring principally to the differences thereof from the first embodiment, while omitting the points thereof which are the same as those in the first embodiment.

The blood treating set 1 according to the second embodiment, as shown in FIG. 2, is the same as that of the first embodiment, except for the configurations of the tube 5 that communicates with the first bag 3, and the tube 10 on the inlet 151 side of the filter 15.

As shown in FIG. 8, in a blood collecting device 2, one end of a flexible tube (first tube) 17 is connected to a lower end portion of the first bag 3, as shown in FIG. 8, so as to communicate with the inside (blood storing part) of the first bag 3. The tube 17 is a tube for discharging blood from the first bag 3 and sending the blood to the filter 15.

The tube 17 has an outside diameter set greater than those of the other tubes 4, 11 to 13. For example, the outside diameter of the tube 17 is set to be about 1.05 to 1.3 times, and preferably about 1.1 to 1.25 times greater than that of the other tubes 4, 11 to 13.

The tube 17 is provided at its end portion with a sealed end portion 171, and is provided at its intermediate portion with a reduced diameter portion 172 where the outside diameter thereof is reduced. The location of the reduced diameter portion 172 on the tube 17 is a predetermined region, inclusive of the connection position (tube connection position) for connection of the tube 17 to a tube 18, which will be described later.

The outside diameter of the reduced diameter portion 172 is equal to or slightly greater than the width of grooves 220 and 320 (in which the tube 17 is to be mounted) formed in the holder 210 of the above-mentioned first tube holding device 200, as well as the holder 310 of the second tube holding device 300. This ensures that the reduced diameter portion 172 can be mounted in the grooves 220 and 320 appropriately and assuredly.

In addition, the outside diameter of the tube 17 (i.e., the outside diameter of portions other than the reduced diameter portion 172) is, for example, about 1.05 to 1.3 times that of the reduced diameter portion 172, and the portion having the larger diameter cannot be inserted (mounted) in the grooves 220, 320. In other words, the tube 17 can be mounted in the grooves 220 and 320 formed in the holder 210 and the holder 310 only at its reduced diameter portion 172. When the reduced diameter portion 172 is mounted in the grooves 220 and 320, the tube 17 can be moved (regulated in position) only slightly in the longitudinal direction, or can be moved only by a short distance, within an extent including a tolerance offset of the tube connection position.

In addition, on the side of the blood treating device 6, the tube (second tube) 18 connected to the inlet 151 side of the filter 15 also has an outside diameter set greater than that of the other tubes 4, 11 to 13 and the like, in the same manner as the tube 17.

The tube 18 is provided at its end portion with a sealed end portion 181, and is provided at its intermediate portion with a reduced diameter portion 182 where the outside diameter is reduced. The location of the reduced diameter portion 182 in the tube 18 is a predetermined region, inclusive of the connection position (tube connection position) for connection of the tube 18 to the tube 17.

The outside diameter of the reduced diameter portion 182 is equal to or slightly greater than the width of grooves 230 and 330 in which the tube 18 is mounted, which are formed in the holder 210 of the first tube holding device 200 and the holder 310 of the second tube holding device 300. This ensures that the reduced diameter portion 182 can be mounted in the grooves 230 and 330 appropriately and assuredly.

In addition, the outside diameter of the tube 18 (the outside diameter of portions other than the reduced diameter portion 182) is, for example, set to be about 1.05 to 1.3 times that of the reduced diameter portion 182, and the portions having the larger diameter cannot be inserted (mounted) in the grooves 230, 330. In other words, the tube 18 can be mounted in the grooves 230 and 330 formed in the holder 210 and the holder 310 only at the reduced diameter portion 182. When the reduced diameter portion 182 is mounted in the grooves 230 and 330, the tube 18 can be moved (regulated in position) only slightly in the longitudinal direction thereof, or can be moved by only a short distance within an extent including a tolerance offset of the tube connection position.

In the above-mentioned manner, the tubes 17 and 18 are mounted in the first tube holding device 200 and the second tube holding device 300 of the tube connecting device 190, and the tube connecting device 190 is operated to connect the tubes, whereby the same effects as in the first embodiment are exhibited. Specifically, the circuit length (channel length) between the first bag 3 and the second bag 7, particularly, the circuit length (channel length) from the end portion on the first bag 3 side of the tube 17 to the inlet 151 of the filter 15, can be made constant through a simple operation. As a result, in the case where the first bag 3 is disposed (suspended) at a higher position and blood is transferred by utilizing a head (difference in height) between the first and second bags, the filtering performance of the filter 15 can be sufficiently exhibited without dispersion, leukocyte removal rate becomes uniform, and a high removal rate is obtained. Therefore, the quality of the obtained blood products is enhanced.

While the present invention has been described above based on the embodiments shown in the figures, the invention is not limited to the disclosed embodiments. Configurations of the component parts may be replaced with other configurations, so long as they can exhibit the same functions as the original configuration, and other arbitrary configurations may be added thereto.

While the filter 15 has been disposed midway in the tube 5 in the above embodiments, the filter may be disposed in an end portion of the tube 5, on the side of the second bag 7. Alternatively, the filter may be disposed at an intermediate portion, or at an end portion of the tube 10 connected to the first bag 3.

While the blood treating device 6 has been described as including a connected bag body, composed of three bags in the above embodiments, the present invention is not limited to this configuration, and a connected bag body composed of two bags or of four or more bags may also be adopted. Naturally, the configuration, use and the like of each of the bags constituting the connected bag body are not particularly limited.

While the blood treating set 1, including the blood collecting device 2 and the blood treating device 6, has been described in the above embodiments as being used in a condition where the liquid to be treated is whole blood, the present invention is not limited to this mode. The liquid to be treated may contain blood components such as concentrated red blood cells, platelets concentrated, etc., or bio-derived cells such as cord blood, bone marrow fluid, gene recombination cells, etc., and may be gene recombination cells to be utilized for recombinant products or the like. Further, the liquid to be treated may contain physiological liquids such as physiological saline, an antioagulant, a preservative liquid, a nutrient liquid, a culture liquid, a cytokine solution (culture promoting liquid) or the like.

In addition, the cell treating set according to the present invention is applicable to treatment of liquids which contain the above-mentioned bio-derived cells, gene recombination cells or the like, and examples of such treatments include: (1) treatments where the liquid to be treated is whole blood or blood components, wherein the treatments involve removing at least one of leukocytes (at least one of monocytes, granulocytes, and limphocytes), platelets, erythrocytes, aggregates, proteins, cytokine, endotoxins, bacteria, viruses, and ions, and recovering the remaining blood components, (2) treatments where the liquid to be treated is cord blood or bone marrow fluid, wherein the treatments involve trapping leukocytes and removing the remaining components, or treatments for removing at least one of platelets, erythrocytes, aggregates, tissue debris, proteins, cytokine, endotoxins, bacteria, viruses, and ions, and recovering the remaining components, (3) treatments where the liquid to be treated is gene recombination cells, wherein the treatments involve removing at least one of cells, aggregates, proteins, cytokine, endotoxins, bacteria, viruses, and ions and recovering the remaining components, and (4) treatments where the liquid to be treated is a liquid containing a cytokine solution or the like for incubating bio-derived cells, wherein the treatments involve trapping the bio-derived cells and removing the remaining components, or treatments for removing at least one of aggregates, tissue debris, proteins, cytokine, endotoxins, bacteria, viruses, and ions, and recovering the remaining components. In such cases, a cell treating set is used, including a liquid storing device, for storing the liquid to be treated, and a cell treating device for performing treatment on the liquid.

As has been described above, according to the present invention, it is possible, when forming a channel by connecting tubes, to make the length of the channel constant through a simple and assured operation. Therefore, in the case where, for example, a filter is present in a circuit, the filtering performance of the filter can be exhibited uniformly and sufficiently, and high filtration efficiency can be stably obtained.

In addition, when conducting operations such as separating and recovering blood components by use of the blood treating set according to the present invention, or in the case of performing separation, recovery or the like of cells using the cell treating set according to the present invention, not only the tube connecting operation, but also the overall operations of the blood treating and cell treating sets can be carried out easily, speedily and accurately.

### INDUSTRIAL APPLICABILITY

According to the blood treating set of the present invention, in the case of aseptically connecting a first tube and a second tube to each other, and transferring blood or a blood component by use of the first tube and the second tube thus connected, the connection position for the tubes can be easily specified, since the first tube and/or the second tube is provided with an indication showing the connection position for the tubes. The first tube and/or the second tube may be provided with a reduced diameter portion formed by reducing the diameter in a predetermined region inclusive of the connection position, as compared with the diameter in other regions. Therefore, the length of a channel for transferring the blood or blood component can be made constant through a simple and assured operation. Therefore, for example, when a filter is present in the circuit, the filtering performance of the filter can be exhibited uniformly and sufficiently, and a high filtration efficiency can be stably obtained. Further, in the case of conducting operations such as separation and recovery of a blood component by use of the blood treating set according to the present invention, not only the tube connecting operation, but also the overall operation of the blood treating set can be carried out easily, speedily and accurately. The same effects as above can also be obtained in the cell treating set according to the present invention. Accordingly, the present invention has industrial applicability.

1. A blood treating set comprising:
a blood collecting device including a first bag for storing collected blood, and a first tube for discharging the blood from said first bag; and
a blood treating device including a second bag for storing blood or a blood component, and a second tube for leading the blood or blood component into said second bag;
said first tube and said second tube being aseptically connected to each other, and the blood or blood component being transferred by use of said first tube and said second tube connected to each other,
wherein said first tube and/or said second tube is provided with an indication for indicating a connection position for said tubes.

2. The blood treating set according to claim 1, wherein said indication indicates the connection position for said first tube and said second tube as a predetermined region.

3. The blood treating set according to claim 1, wherein when said first tube and said second tube are connected to each other according to said indication, a length of said tubes after connection is substantially constant.

4. The blood treating set according to claim 1, further comprising a filter for removing a predetermined component, said filter being provided midway in said first tube or said second tube.

5. The blood treating set according to claim 4, wherein said filter is a leukocyte removing filter.

6. The blood treating set according to claim 1, wherein said blood treating device includes a connected bag body having said second bag and at least one other bag connected to said second bag.

7. The blood treating set according to claim 1, wherein said blood treating device is operative to conduct a blood separating treatment, for separating blood into a plurality of blood components by centrifugation and recovery of said blood components.

8. A blood treating set comprising:
a blood collecting device including a first bag for storing collected blood, and a first tube for discharging the blood from said first bag; and
a blood treating device including a second bag for storing blood or a blood component, and a second tube for leading the blood or blood component into said second bag;
said first tube and said second tube being aseptically connected to each other, and the blood or blood component being transferred by use of said first tube and said second tube connected to each other,
wherein said first tube and/or said second tube is provided with a reduced diameter portion formed by reducing the tube diameter in a predetermined region inclusive of the connection position of said tubes, as compared with that in the other regions.

9. The blood treating set according to claim 8, wherein said reduced diameter portion has an outside diameter such that said reduced diameter portion can be mounted in a tube holding part of a tube connecting device.

10. The blood treating set according to claim 9, wherein when said first tube and said second tube are connected to each other with said reduced diameter portion mounted in said tube holding part of said tube connecting device, a length of said tubes after connection is substantially constant.

11. The blood treating set according to claim 8, further comprising a filter for removing a predetermined component, said filter being provided at an intermediate portion or an end portion of said first tube or said second tube.

12. The blood treating set according to claim 11, wherein said filter is a leukocyte removing filter.

13. The blood treating set according to claim 8, wherein said blood treating device includes a connected bag body having said second bag and at least one other bag connected to said second bag.

14. The blood treating set according to claim 8, wherein said blood treating device is operative to conduct a blood separating treatment, for separating blood into a plurality of blood components by centrifugation and recovery of said blood components.

15. A cell treating set comprising:
a liquid storing device including a first bag for storing a liquid containing bio-derived cells, and a first tube for discharging said liquid from said first bag;
a cell treating device including a second bag for storing the treated liquid, and a second tube for leading said treated liquid into said second bag; and
a filter for separating a predetermined component of said liquid, said filter being provided midway in said first tube or said second tube;
said first tube and said second tube being aseptically connected to each other, and said liquid being transferred by use of said first tube and said second tube connected to each other,
wherein said first tube and/or said second tube is provided with an indication for indicating a connection position for said tubes.

16. The cell treating set according to claim 15, wherein said indication indicates said connection position for said first tube and said second tube as a predetermined region.

17. The cell treating set according to claim 15, wherein when said first tube and said second tube are connected to each other according to said indication, a length of said tubes after connection is substantially constant.
